(19) United States
(12) Patent Application Publication
(10) Pub. No.: US 2019/0121200 A1
(43) Pub. Date: Apr. 25, 2019

(54) FABRICATION METHOD OF DEFLECTING FILM

(71) Applicant: HEFEI UNIVERSITY OF TECHNOLOGY, Hefei (CN)

(72) Inventors: QIBIN FENG, HEFEI (CN); GUOQIANG LV, HEFEI (CN); ZI WANG, HEFEI (CN)

(21) Appl. No.: 16/217,014

(22) Filed: Dec. 11, 2018

Related U.S. Application Data
(63) Continuation of application No. PCT/CN2016/085488, filed on Jun. 12, 2016.

(51) Int. Cl. G02F 1/1335; G02F 1/295; G01N 21/41

(52) U.S. Cl. CPC G02F 1/133606; G01N 2021/4153; G01N 21/4133; G02F 1/295

(57) ABSTRACT

The application relates to a fabrication method of a deflecting film capable of realizing a deflection of a viewing angle of the liquid crystal display device. According to viewing angle characteristics of a backlight unit of the liquid crystal display device and deflection angle requirement of maximum luminance, one or more layers of deflecting film is/are fabricated and used in the backlight unit of the liquid crystal display device. The deflecting film deflects a viewing angle of the maximum luminance of the liquid crystal display device to the direction of the viewer's sight, and a shape of the viewing angle curve does not change significantly, so that the light is utilized to the utmost extent, the energy consumption is reduced, and the light effect is improved.

### FIELD OF THE DISCLOSURE

The disclosure relates to the field of liquid crystal display technologies, and more particularly to a fabrication method of a deflecting film capable of deflecting a specific viewing angle of a liquid crystal display device.

### BACKGROUND

With the rapid development of flat panel display technology, liquid crystal displays (LCDs) have replaced traditional cathode ray tubes in many fields and have become a mainstream display device. The LCD itself does not emit light and requires a backlight unit to provide light to illuminate the display area. Therefore, the luminance, uniformity, and viewing angle of the backlight have a great influence on the optical performance of the terminal display.

When used in TV, laptop, and mobile phone, the viewing direction of a reader is perpendicular to the display, which means the maximum luminance of a LCD happening at normal degree is directed to viewers. However, when used in automobile and airplane, as the fact that the drivers have to observe the outside status through the windshield, the eyes of a driver are necessarily higher than the LCD. If the LCD is installed vertically, there would be certain angle between the driver and the normal direction of the LCD, which means that the maximum luminance happening at the normal direction of the LCD will not direct to the driver. In such situation, in order to satisfy the luminance requirement at the certain angle, the luminance at the normal direction has to be very high, leading to power waste and design difficulty because the maximum luminance at the normal direction is not used. Therefore, LCDs in automotive and airplane are usually installed with certain inclination angle to orient display image to viewers, which requires larger installation space. One solution is to control the viewing angle of a backlight unit to make the maximum luminance happen at certain angle, which can reduce the requirements both on design and installation space.

### SUMMARY

The present invention provides a fabrication method of a deflecting film, wherein the deflecting film is capable of deflecting a specific viewing angle of the liquid crystal display device.

In the disclosure, a fabrication method of a deflecting film capable of realizing a deflection of a viewing angle of a liquid crystal display device is provided. The liquid crystal display device comprises a backlight unit and a liquid crystal panel, the backlight unit comprises a light source, a light guide plate, a reflective film, a lower diffusion film, an upper diffusion film and a deflecting film. The light guide plate comprises a light incident surface, a light emitting surface adjacent to the light incident surface and four light leakage surfaces, the light source is disposed corresponding to the light incident surface of the light guide plate, and the reflective film is disposed below the light leakage surfaces. The lower diffusion film, the upper diffusion film and the deflecting film are sequentially disposed above the light emitting surface in that order. The liquid crystal panel is disposed above the deflecting film, and a surface of the deflecting film is filled with optical curved-surface structures. The fabrication method of the deflecting film comprises preparing the optical curved surface structures of the deflecting film comprising:

step S01, determining α₂ according to a required deflection angle of the liquid crystal display device;

step S02, defining a distance x₁₀ between the deflecting film and the upper diffusion film;

step S03, determining x₂₀ according to a reserved thickness of the optical adhesive and a height of the surface microstructure on the surface of the deflecting film, wherein the x₂₀ is a sum of the distance x₁₀, the reserved thickness of the optical adhesive and the height of the surface microstructure;

step S04, determining x₃₀ according to a distance between the liquid crystal panel and the deflecting film, wherein the x₃₀ is a sum of the x₂₀ and the distance between the liquid crystal panel and the deflecting film;

step S05, determining a refractive index n₁ according to a medium before the deflecting film, and determining a refractive index n₂ according to a medium of the deflecting film;

step S06, determining a range of an incident angle θ₁ according to an angle θ at the half-luminance of a viewing angle curve of incident light entering the deflecting film, wherein the incident angle θ₁ is in the range of [−θ₁ₘₐₓ, θ₁ₘₐₓ], and θ₁ₘₐₓ is smaller than 90°;

step S07, determining α₁ according to the following formulas when θ₁=0°:

$$\{ \begin{matrix}{n}_{1} sin ( {θ}_{1} + {α}_{1} ) = {n}_{2} sin ( {θ}_{2} + {α}_{1} ) \\ {n}_{2} sin {θ}_{2} = {n}_{1} sin ( {θ}_{1} + {α}_{2} )\end{matrix} ;$$

step S08, assuming that x₀=0, y₀=0, y₁₀=0, y₂₀=0, y₃₀=0;

step S09, segmenting θ₁ with the interval of Δθ and −Δθ. Starting from 0°, a series of θ₁ᵢ and −θ₁ᵢ can be obtained, wherein θ₁ᵢ₊₁=θ₁ᵢ+Δθ, and i is from 0 to an integral part of θ₁ₘₐₓ/Δθ; −θ₁ᵢ₊₁=−θ₁ᵢ−Δθ, and i is from 0 to an integral part of −θ₁ₘₐₓ/Δθ;

step S10, substituting i=1, θ₁₁=Δθ and i=−1, θ₁₁=−Δθ into the following formulas to obtain a first group of the coordinate points x₁₁, y₁₁, x₂₁, y₂₁, x₃₁, y₃₁ of the upper half of the curved surface and the first group of the coordinate points x₋₁₁, y₋₁₁, x₋₂₁, y₋₂₁, x₋₃₁, y₋₃₁ of a lower half of the curved surface; substituting i=2, θ₁₂=2×Δθ and i=−2, −θ₁₂=−2×(−Δθ) into the following formulas to obtain the second group of the coordinate points x₁₂, y₁₂, x₂₂, y₂₂, x₃₂, y₃₂ of the upper half of the curved surface and the second group of the coordinate points x₋₁₂, y₋₁₂, x₋₂₂, y₋₂₂, x₋₃₂, y₋₃₂ of the lower half of the curved surface; and so on, until substituting the integer part of i=θ₁ₘₐₓ/Δθ, θ₁ᵢ=θ₁ₘₐₓ and the integer part of i=−θ₁ₘₐₓ/Δθ, −θ₁ᵢ=−θ₁ₘₐₓ into the following formulas to obtain the last group of the coordinate points x₁ₘₐₓ, y₁ₘₐₓ, x₂ₘₐₓ, y₂ₘₐₓ, x₃ₘₐₓ, y₃ₘₐₓ of the upper half of the curved surface and the last group of the coordinate points x₋₁ₘₐₓ, y₋₁ₘₐₓ, x₋₂ₘₐₓ, y₌₂ₘₐₓ, x₋₃ₘₐₓ, y₋₃ₘₐₓ of the lower half of the curved surface;

$$\{ \begin{matrix}{n}_{1} sin ( {θ}_{1 i} + {α}_{1 i} ) = {n}_{2} sin ( {θ}_{2 i} + {α}_{1 i} ) \\ {n}_{2} sin {θ}_{2 i} = {n}_{1} sin ( {θ}_{1 i} + {α}_{2 i} ) \\ tan {θ}_{1 i} = \frac{{y}_{1 i} - {y}_{0}}{{x}_{1 i} - {x}_{0}} \\ tan {θ}_{2 i} = \frac{{y}_{2 i} - {y}_{1 i}}{{x}_{2 i} - {x}_{1 i}} \\ tan ( 90 ° - {α}_{1 i} ) = \frac{{y}_{1 i} - {y}_{10}}{{x}_{1 i} - {x}_{10}} \\ tan ( {θ}_{1} + {α}_{2 i} ) = \frac{{y}_{3 i} - {y}_{2 i}}{{x}_{3 i} - {x}_{2 i}} \\ {x}_{20} = {x}_{21} \\ {x}_{30} = {x}_{31}\end{matrix} ;$$

step S11, based on a right-angle curved surface structure, connecting a series of obtained coordinate points (x₁₁, y₁₁), (x₁₂, y₁₂), . . . , (x₁ₘₐₓ, y₁ₘₐₓ) of the upper half of the curved surface, at right angles by combining the reserved thickness of optical adhesive, and thereby forming an upper half of a single one of the optical curved surface structures;

step S12, based on a right-angle curved surface structure, connecting the series of obtained coordinate points (x₋₁₁, y₋₁₁), (x₋₁₂, y₋₁₂), . . . , (x₋₁ₘₐₓ, y₋₁ₘₐₓ) of the lower half of the curved surface at right angles by combining the reserved thickness of optical adhesive, and thereby forming a lower half of the single curved surface structure;

step S13, combining the upper half and the lower half of the single curved surface structure at the coordinate point of (x₁₀, y₁₀), and thereby forming a complete single optical curved surface structure on the surface of the deflecting film; and

step S14, repeating the completed single curved surface structure to form a matrix of 100×100 on the surface of the deflecting film, placing the matrix above the upper diffusion film, and using an optical software for simulation to obtain a viewing angle curve and thereby a viewing angle with the maximum luminance is obtained.

In an embodiment, before preparing the deflecting film with the optical curved surface structures, further comprising: determining the amount of layers of the deflecting film according to the required deflection angle of the viewing angle of the liquid crystal display device; wherein when the deflection angle is greater than or equal to 20°, the number of layers N of the deflecting film are needed to be prepared, where N=an integer part of (deflection angle/20°)+1; and when the deflection angle is less than 20°, one layer of the deflecting film is needed to be prepared.

In an embodiment, when N layers of deflecting film are needed to be prepared, the optical curved surface structures of the N layers of deflecting film are prepared by the following method comprising:

preparing a first layer of deflecting film according to the above steps S01-S14, wherein a deflection angle of the first layer of deflecting film is determined as the required deflection angle α₂ divided by N;

preparing an m-th layer of deflecting film comprises:
based on an acute-angle curved surface structure, connecting the series of coordinate points (xₘ₁, yₘ₁), (xₘ₂, yₘ₂), . . . (xₘₘₐₓ, yₘₘₐₓ) obtained during preparing the first layer of the deflecting film and combining with the reserved optical adhesive through an acute-angle, to form the acute-angle curved surface structure of the m-th layer, wherein the acute angle of the m-th layer of deflecting film is 90°−α₂*(m−1)/N, m=2˜N; and
repeating the single acute-angle curved surface structure to form a matrix of 100×100 on a surface of the m-th layer of deflecting film, disposing the N layers of deflecting film above the upper diffusion film, and using the optical software for simulation to obtain a viewing angle curve and thereby a viewing angle with a maximum luminance is obtained.

In an embodiment, after the step S14, further comprising: step S15, determining whether the deflection of the viewing angle and the transmittance of the liquid crystal display device satisfies the requirement; if being satisfied, forming a plurality of the optical curved surface structures according to the actual size of the deflecting film; and if not being satisfied, narrowing the range of the incident angle θ₁, and repeating the steps S07 to S14 until meeting the requirements.

In an embodiment, the optical curved surface structures on the surface of the deflecting film comprise a plurality of wavy microstructures, or a plurality of sawtooth microstructures, or a combination of a plurality of wavy microstructures and a plurality of sawtooth microstructures.

In an embodiment, after the step S15, further comprising: preparing a mold for the deflecting film with the optical curved surface structures; and using the mold to manufacture the deflecting film with the optical curved surface structures.

In an embodiment, preparing a mold for the deflecting film with the optical curved surface structures comprises: providing a base and coating optical adhesive on the base, wherein a thickness of the optical adhesive is greater than 20 um; processing the optical adhesive by a photolithography process, thereby forming an optical adhesive layer with the optical curved surface structures thereon; curing the optical adhesive layer with the optical curved surface structures by baking; and electroplating the optical adhesive layer with the optical curved surface structures, thereby forming the mold.

The fabrication method of the present disclosure fabricates the single-layer or the matched multi-layer of the deflecting film provided with the curved surface structures, according to the existing viewing angle characteristics of the backlight unit of the liquid crystal display device and the maximum luminance deflection angle requirement. One or more matched deflecting films are used in the backlight unit of the liquid crystal display device, the curved surface structures of the deflecting film can be fabricated according to the deflection angle of maximum luminance of the liquid crystal display device, and the maximum luminance of the liquid crystal display device can be deflected to sight direction of viewers, meanwhile the viewing angle curve will not change significantly. So the light is mostly used, energy consumption is reduced and light efficiency is improved. At the same time, when the viewing angle of the liquid crystal display device is large, multi-layers of deflecting film is used to solve the problem that the existing single-layer of deflecting film has a gain and a cut-off angle when the deflection angle is large, and the light efficiency is further improved.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are: merely some embodiments of the disclosure, a person skilled in the art can obtain other drawings according to these drawings without creative efforts. In the drawings:

FIG. 1 is a schematic diagram showing a fabrication principle of microstructures provided on a surface of a deflecting film.

FIG. 2 is a viewing angle curve 1 of a backlight unit of a liquid crystal display of prior art.

FIG. 3 is a schematic structural view of an upper half of a curved surface structure, according to a first embodiment of the present disclosure.

FIG. 4 is a schematic structural view of a lower half of a curved surface structure, according to a first embodiment of the present disclosure.

FIG. 5 is a viewing angle curve obtained in such a manner that the viewing angle curve 1 is deflected by one layer of deflecting film having a function of deflecting 10° of viewing angle.

FIG. 6 is a viewing angle curve 2 of a backlight unit of a liquid crystal display of prior art.

FIG. 7 is a schematic structural view of a microstructure on a surface of one layer of deflecting film, which has a function of deflecting 10° of viewing angle for the viewing angle curve 2.

FIG. 8 is a viewing angle curve obtained in such a manner that the viewing angle curve 2 is deflected by one layer of deflecting film having a function of deflecting 10° of viewing angle.

FIG. 9 is a schematic structural view of microstructures on surfaces of double layers of deflecting film, which have a function of deflecting 20° of viewing angle for the viewing angle curve 1.

FIG. 10 is a viewing angle curve obtained in such a manner that the viewing angle curve 1 is deflected by double layers of deflecting film having a function of deflecting 20° of viewing angle.

FIG. 11 are schematic structural views of microstructures on surfaces of three layers of deflecting film, which have a function of deflecting 40° of viewing angle for the viewing angle curve 1.

FIG. 12 is a viewing angle curve obtained in such a manner that the viewing angle curve 1 is deflected by three layers of deflecting film having a function of deflecting 40° of viewing angle.

FIG. 13 is a structural schematic view of a liquid crystal display device of the present disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

Unless otherwise defined, all technical and scientific terms used herein have the same meaning as commonly understood by one of ordinary skill in the art. The terminology used in the description of the present disclosure is for the purpose of describing particular embodiments and is not intended to limit the disclosure. The term “and/or” used herein includes any and all combinations of one or more of the associated listed items.

Referring to FIG. 13, the disclosure provides a fabrication method of a deflecting film 26, wherein the deflecting film 26 is capable of realizing a deflection of a viewing angle of a liquid crystal display device 10, the liquid crystal display device 10 comprises a backlight unit 20 and a liquid crystal panel 30.

The backlight unit 20 includes a light source 21, a light guide plate 22, a reflective film 23, a lower diffusion film 24, an upper diffusion film 25, and the deflecting film 26. The light guide plate 22 includes a light incident surface 221, a light emitting surface 222 adjacent to the light incident surface 221, and four light leakage surface 223. The light source 21 is disposed corresponding to the light incident surface 221 of the light guide plate 22. The reflective film 23 is disposed below the light leakage surfaces 223. The lower diffusion film 24, the upper diffusion film 25 and the deflecting film 26 are sequentially disposed above the light emitting surface 222 in that order. The liquid crystal panel 30 is disposed above the deflecting film 26. A surface of the deflecting film 26 is provided with optical curved surface structures 262.

It can be understood that the backlight unit 20 described above in the present application is a side-in type backlight unit, and in practice, a direct type backlight unit also is suitable. Specifically, the direct type backlight unit includes a light source, a reflective film, a lower diffusion film, an upper diffusion film, and the deflecting film. The reflective film is disposed below the light source, and the lower diffusion film, the upper diffusion film and the deflecting film are sequentially disposed along a light emitting direction of the light source. A surface of the deflecting film is provided with optical curved surface structures.

According to the above description, in the fabrication method of the deflecting film provided by the present application, whether the backlight unit involved is a direct type backlight unit or a side-in type backlight unit, the viewing angle of the liquid crystal display device can be deflected by the fabrication of the deflecting film.

The disclosure will be further clearly described in detail with reference to accompanying drawings and preferred embodiments as follows.

### Embodiment 1

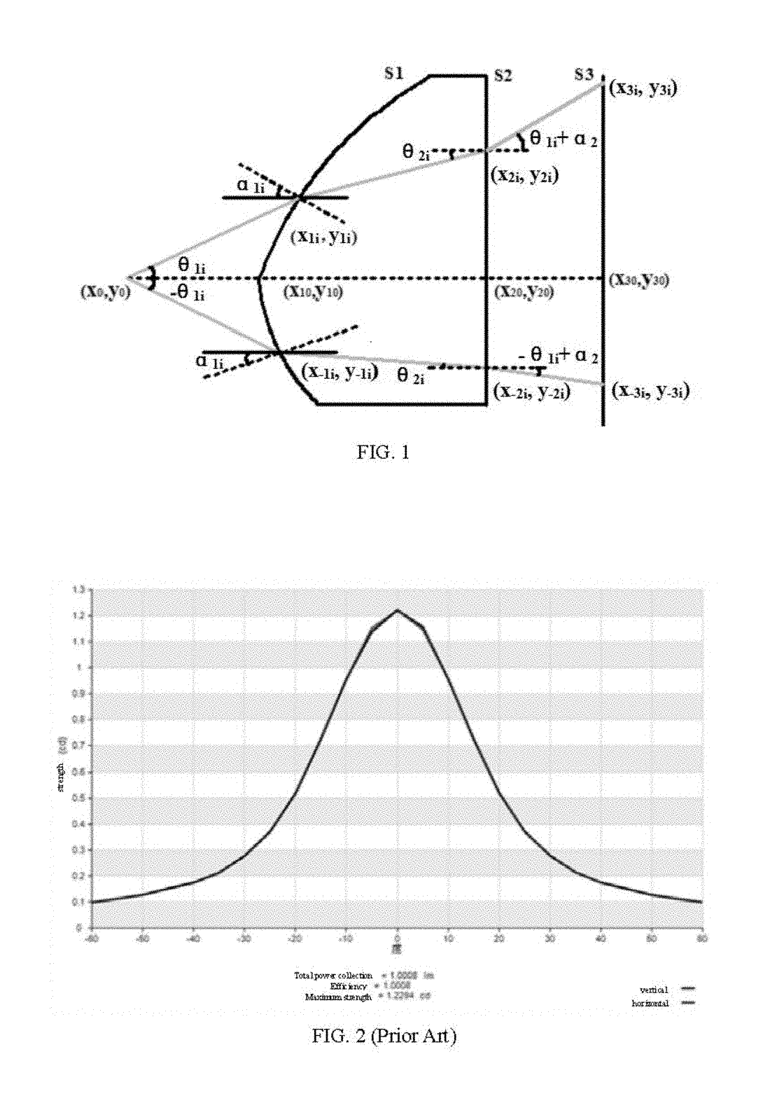

The first embodiment of the present disclosure provides a fabrication method of a deflecting film capable of deflecting a viewing angle of a liquid crystal display, please refer to FIG. 1 for understanding. The present embodiment fabricates a deflecting film used in a backlight unit whose viewing angle curve is shown in FIG. 2. Since the viewing angle of the maximum luminance of the liquid crystal display device is 10°, just one layer of deflecting film is fabricated in the liquid crystal display device. The fabrication method specifically includes the following steps.

Step 1, according to design requirements, a deflection angle of the maximum luminance is 10°, so α₂=10°.

Step 2, the deflecting film is disposed directly above a top side of the backlight unit, so a distance between the deflecting film and the backlight unit is 5 um, that is x₁₀=5.

Step 3, a reserved thickness of optical adhesive is 10 um, and a height of surface microstructures is 10 um, so x₂₀=25.

Step 4, the liquid crystal panel is directly disposed above the deflecting film, a distance between the deflecting film and the liquid crystal panel is selected as 5 um, so x₃₀=30.

Step 5, a light enters to the deflecting film from air, so n₁ is the refractive index of air, n₁=1, n₂ is the refractive index of the optical adhesive, n₂=1.57.

Step 6, the viewing angle curve of incident light is as shown in FIG. 2, in the viewing angle curve, the viewing angle θ at half of the maximum luminance is 20°, so the incident angle θ₁∈[−20°, 20°].

Step 7, when θ₁=0°, α₁=17.2° is calculated according to the following formulas:

$$\{ \begin{matrix}sin ( {θ}_{1} + {α}_{1} ) = 1.57 sin ( {θ}_{2} + {α}_{1} ) \\ 1.57 sin {θ}_{2} = sin ( {θ}_{1} + 10 ° )\end{matrix} .$$

Step 8, assuming that x₀=0, y₀=0, y₁₀=0, y₂₀=0, y₃₀=0.

Step 9, the set θ₁ is performed a segmentation every 0.5° and −0.5° to obtain a series of θ₁ᵢ and −θ₁ᵢ, where θ₁ᵢ+1=θ₁ᵢ+0.5°, i={0˜20}/0.5={0˜40}, −θ₁ᵢ+1=−θ₁ᵢ−0.5°, i={−20/0.5˜0}={−40˜0}.

Step 10, substituting θ₁ᵢ and −θ₁ᵢ corresponding to i={−40˜40} into the following formulas, calculating 40 coordinate points of an upper half of a curved surface S1 and 40 coordinate points of a lower half of the curved surface S1. Wherein S1 refers to a curved top surface of the curved surface structure, 40 coordinate points of the upper half of the curved surface S1 correspond to i={0˜40} and θ₁ᵢ∈[0, 20°], and 40 coordinate points of the lower half of the curved surface S1 correspond to i={−40˜0} and −θ₁ᵢ∈[−20°, 0]. Due to the limited space of the description, only values of the middle 21 coordinate points are given here, as illustrated in the following table.

$$\{ \begin{matrix}{n}_{1} sin ( {θ}_{1 i} + {α}_{1 i} ) = {n}_{2} sin ( {θ}_{2 i} + {α}_{1 i} ) \\ {n}_{2} sin {θ}_{2 i} = {n}_{1} sin ( {θ}_{1 i} + {α}_{2 i} ) \\ tan {θ}_{1 i} = \frac{{y}_{1 i} - {y}_{0}}{{x}_{1 i} - {x}_{0}} \\ tan {θ}_{2 i} = \frac{{y}_{2 i} - {y}_{1 i}}{{x}_{2 i} - {x}_{1 i}} \\ tan ( 90 ° - {α}_{1 i} ) = \frac{{y}_{1 i} - {y}_{10}}{{x}_{1 i} - {x}_{10}} \\ tan ( {θ}_{1} + {α}_{2 i} ) = \frac{{y}_{3 i} - {y}_{2 i}}{{x}_{3 i} - {x}_{2 i}} \\ {x}_{20} = {x}_{21} \\ {x}_{30} = {x}_{31}\end{matrix}$$

| | x₁ᵢ | y₁ᵢ |
|---|---|---|
| i = −10 | 4.881 | −0.384 |
| i = −9 | 4.894 | −0.342 |
| i = −8 | 4.907 | −0.3 |
| i = −7 | 4.92 | −0.258 |
| i = −6 | 4.933 | −0.215 |
| i = −5 | 4.946 | −0.173 |
| i = −4 | 4.96 | −0.13 |
| i = −3 | 4.973 | −0.087 |
| i = −2 | 4.986 | −0.044 |
| i = −1 | 5 | 0 |
| i = 0 | 5 | 0 |
| i = 1 | 5 | 0 |
| i = 2 | 5.014 | 0.044 |
| i = 3 | 5.027 | 0.088 |
| i = 4 | 5.041 | 0.132 |
| i = 5 | 5.055 | 0.177 |
| i = 6 | 5.069 | 0.221 |
| i = 7 | 5.083 | 0.266 |
| i = 8 | 5.097 | 0.312 |
| i = 9 | 5.111 | 0.357 |
| i = 10 | 5.126 | 0.403 |

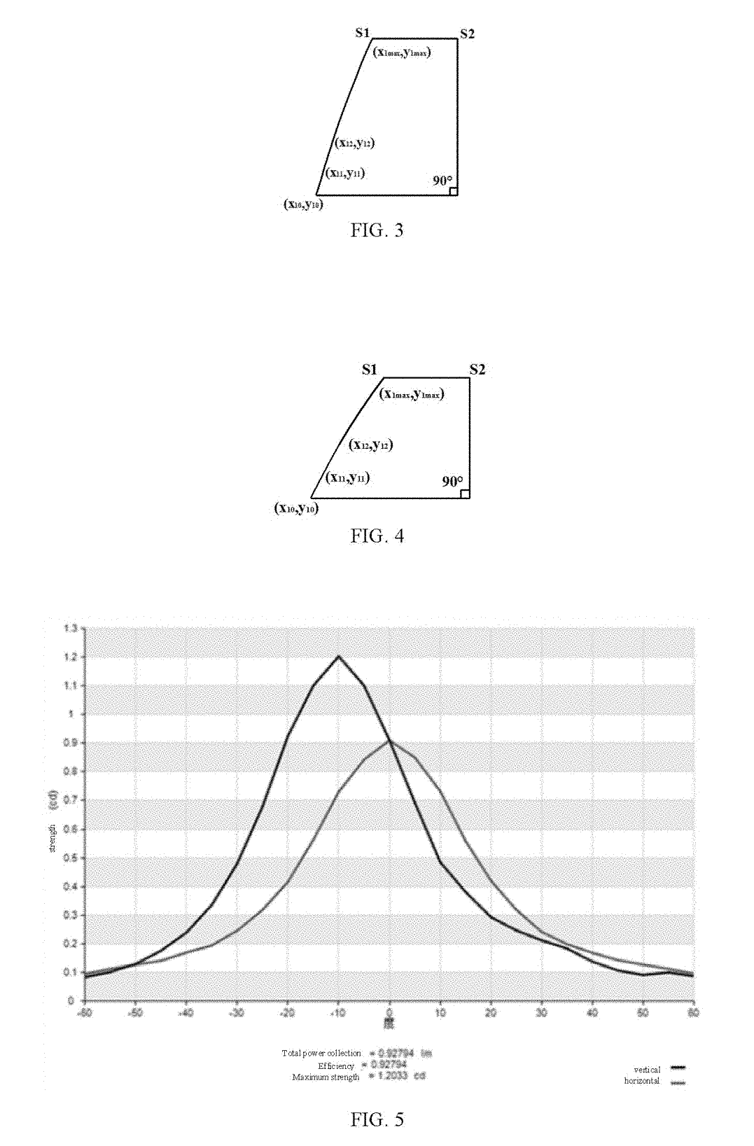

Step 11, connecting the 40 coordinate points of the upper half of the curved surface S1, at right angles combining a top surface S2 of the reserved thickness of the optical adhesive, and thereby forming an upper half of a single one of the optical curved surface structures based on a drawing software, as shown in FIG. 3.

Step 12, connecting the 40 coordinate points of the lower half of the curved surface S1, at right angles combining the top surface S2 of the reserved thickness of the optical adhesive, and thereby forming a lower half of a single one of the optical curved surface structures based on the drawing software, as shown in FIG. 4.

Step 13, combining the upper half and the lower half of the curved surface structure at the coordinate point of (x₁₀, y₁₀), thereby forming a complete single optical curved surface structure provided on the surface of the deflecting film.

Step 14, repeating the completed single curved surface structure to form a matrix of 100×100 on the surface of the deflecting film, placing the matrix above the upper diffusion film, and using an optical software for simulation to obtain a viewing angle curve and thereby a viewing angle with a maximum luminance is obtained, as shown in FIG. 5. It can be seen that the viewing angle of maximum luminance is 10° and the transmittance is 97.9%, thereby satisfying the requirements. According to the actual size of the deflecting film, a plurality of optical curved surface structures are prepared on the surface of the deflecting film, in a later preparing process.

### Embodiment 2

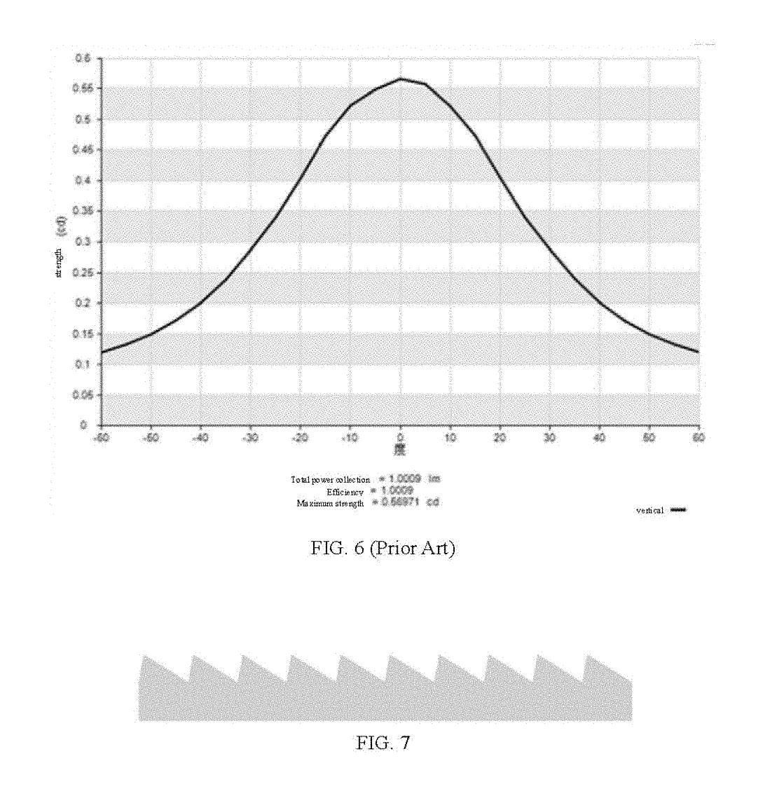

The second embodiment of the present disclosure provides a fabrication method of a deflecting film capable of deflecting a viewing angle of a liquid crystal display, please refer to FIG. 1 for understanding. The present embodiment fabricates a deflecting film used in a backlight unit whose viewing angle curve is shown in FIG. 6. Since the viewing angle of the maximum luminance of the liquid crystal display device is 10°, just one layer of deflecting film is fabricated in the liquid crystal display device. The fabrication method specifically includes the following steps.

Step 1, according to design requirements, a deflection angle of the maximum luminance is 10°, so α₂=10°.

Step 2, the deflecting film is disposed directly above a top side of the backlight unit, so a distance between the deflecting film and the backlight unit is 5 um, that is x₁₀=5.

Step 3, a reserved thickness of optical adhesive layer is 10 um, and a height of surface microstructures is 10 um, so x₂₀=25.

Step 4, the liquid crystal panel is directly disposed above the deflecting film, a distance between the deflecting film and the liquid crystal panel is selected as 5 um, so x₃₀=30.

Step 5, a light enters to the deflecting film from air, so n₁ is the refractive index of air, n₁=1, n₂ is the refractive index of the optical adhesive, n₂=1.57.

Step 6, the viewing angle curve of incident light is as shown in FIG. 6, in the viewing angle curve, the viewing angle θ at half of the maximum luminance is 30°, so the incident angle θ₁∈[−30°, 30°].

Step 7, when θ₁=0°, α₁=17.2° is calculated according to the following formulas:

$$\{ \begin{matrix}sin ( {θ}_{1} + {α}_{1} ) = 1.57 sin ( {θ}_{2} + {α}_{1} ) \\ 1.57 sin {θ}_{2} = sin ( {θ}_{1} + 10 ° )\end{matrix} .$$

Step 8, assuming that x₀=0, y₀=0, y₁₀=0, y₂₀=0, y₃₀=0.

Step 9, the set θ₁ is performed segmentations every 0.5° and −0.5° to obtain a series of θ₁ᵢ and −θ₁ᵢ, where θ₁ᵢ+1=θ₁ᵢ+0.5°, i={0˜30}/0.5={˜60}, −θ₁ᵢ+1=−θ₁ᵢ−0.5°, i={−30/0.5˜0}={−60˜0}.

Step 10, substituting θ₁ᵢ and −θ₁ᵢ corresponding to i={−60˜60} into the following formulas, calculating 60 coordinate points of an upper half of a curved surface S1 and 60 coordinate points of a lower half of the curved surface S1. Wherein S1 refers to a curved top surface of the optical curved surface structure, 60 coordinate points of the upper half of curved surface S1 correspond to i={0˜60} and θ₁ᵢ∈[0, 30°], 60 coordinate points of the lower half of curved surface S1 correspond to i={−60˜0} and −θ₁ᵢ∈[−30°, 0]. Due to the limited space of the description, only values of the middle 21 coordinate points are given here, as illustrated in the following table.

$$\{ \begin{matrix}{n}_{1} sin ( {θ}_{1 i} + {α}_{1 i} ) = {n}_{2} sin ( {θ}_{2 i} + {α}_{1 i} ) \\ {n}_{2} sin {θ}_{2 i} = {n}_{1} sin ( {θ}_{1 i} + {α}_{2 i} ) \\ tan {θ}_{1 i} = \frac{{y}_{1 i} - {y}_{0}}{{x}_{1 i} - {x}_{0}} \\ tan {θ}_{2 i} = \frac{{y}_{2 i} - {y}_{1 i}}{{x}_{2 i} - {x}_{1 i}} \\ tan ( 90 ° - {α}_{1 i} ) = \frac{{y}_{1 i} - {y}_{10}}{{x}_{1 i} - {x}_{10}} \\ tan ( {θ}_{1} + {α}_{2 i} ) = \frac{{y}_{3 i} - {y}_{2 i}}{{x}_{3 i} - {x}_{2 i}} \\ {x}_{20} = {x}_{21} \\ {x}_{30} = {x}_{31}\end{matrix}$$

| | x₁ᵢ | y₁ᵢ |
|---|---|---|
| i = −10 | 4.881 | −0.384 |
| i = −9 | 4.894 | −0.342 |
| i = −8 | 4.907 | −0.3 |
| i = −7 | 4.92 | −0.258 |
| i = −6 | 4.933 | −0.215 |
| i = −5 | 4.946 | −0.173 |
| i = −4 | 4.96 | −0.13 |
| i = −3 | 4.973 | −0.087 |
| i = −2 | 4.986 | −0.044 |
| i = −1 | 5 | 0 |
| i = 0 | 5 | 0 |
| i = 1 | 5 | 0 |
| i = 2 | 5.014 | 0.044 |
| i = 3 | 5.027 | 0.088 |
| i = 4 | 5.041 | 0.132 |
| i = 5 | 5.055 | 0.177 |
| i = 6 | 5.069 | 0.221 |
| i = 7 | 5.083 | 0.266 |
| i = 8 | 5.097 | 0.312 |
| i = 9 | 5.111 | 0.357 |
| i = 10 | 5.126 | 0.403 |

Step 11, connecting the 60 coordinate points of the upper half of the curved surface S1, at right angles combining with a surface S2 of the reserved thickness of optical adhesive, and thereby forming an upper half of a single one optical curved surface structure based on a drawing software.

Step 12, connecting the 60 coordinate points of the lower half of the curved surface S1, at right angles by combining with the surface S2 of the reserved thickness of optical adhesive and thereby forming a lower half of the single one optical curved surface structure based on the drawing software.

Step 13, combining the upper half and the lower half of the optical curved surface structure at the coordinate point of (x₁₀, y₁₀), thereby forming a complete curved surface structure provided on the surface of the deflecting film, as shown in FIG. 7.

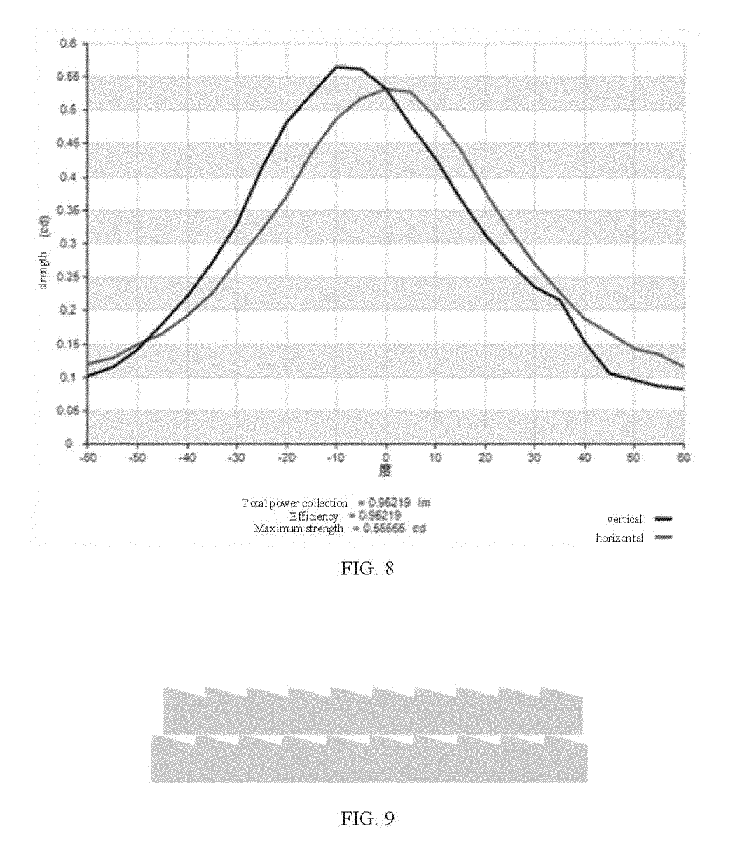

Step 14, repeating the completed single curved surface structure to form a matrix of 100×100 on the surface of the deflecting film, placing the matrix above the upper diffusion film, and using an optical software for simulation to obtain a viewing angle curve, as shown in FIG. 8. It can be seen that the viewing angle of maximum luminance is 10° and the transmittance is 99.3%, thereby satisfying the design requirements. According to the actual size of the deflecting film, a plurality of optical curved surface structures are prepared on the surface of the deflecting film, in a later preparing process.

### Embodiment 3

A third embodiment of the present disclosure provides a fabrication method of a deflecting film capable of deflecting a viewing angle of a liquid crystal display, please refer to FIG. 1 for understanding. The present embodiment fabricates deflecting films used in a backlight unit whose viewing angle curve is shown in FIG. 2. Since the viewing angle of the maximum luminance of the liquid crystal display device is 20°, double layers of deflecting film are fabricated in the liquid crystal display device. The fabrication method specifically includes the following steps.

Step 1, determining a deflection angle of a first layer of deflecting film is 20°/2=10°, a deflection angle of a second layer of deflecting film is 20°-10°=10°.

Step 2, according to the first embodiment, the curved surface structure of the first layer of deflecting film is determined, with fabrication steps and deflecting film structures the same as those of the first embodiment.

Step 3, determining a curved surface structure of the second layer of deflecting film according to the curved surface structure of the first layer of deflecting film, a curved surface portion of the second layer of deflecting film is the same as that of the first layer of deflecting film, the right angles in curved surface structure of the first layer of deflecting film are changed to be acute angles of the curved surface structure of the second layer of deflecting film, and the acute angle is 90°−20°*(2−1)/2=80°, thereby obtaining a single curved surface structure of the second layer of deflecting film.

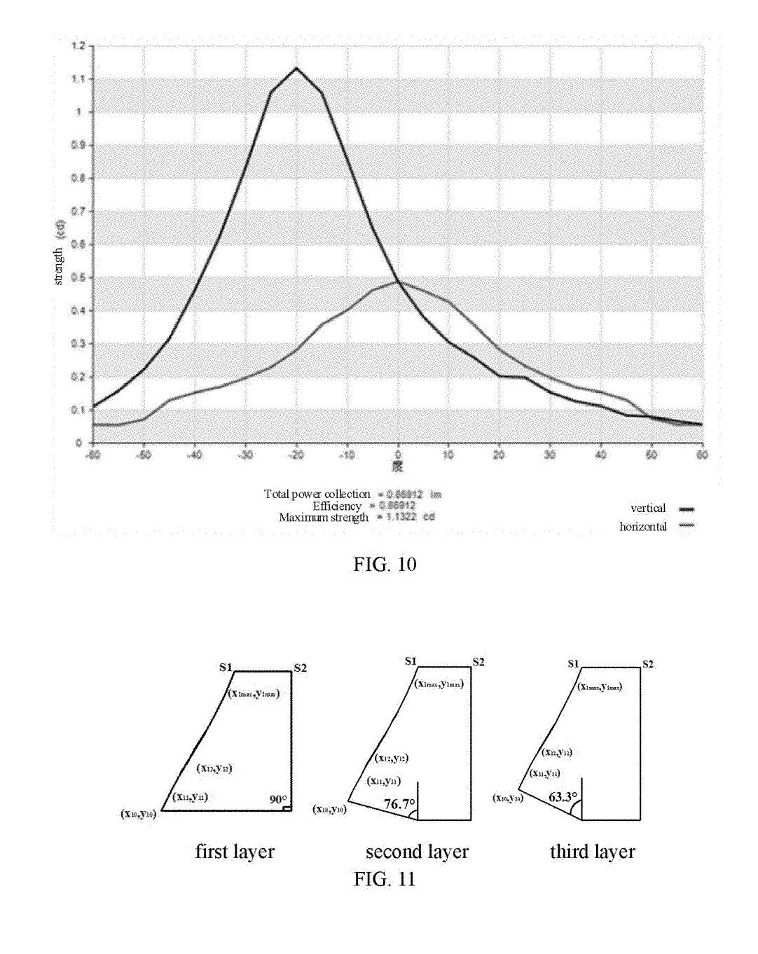

Step 4, duplicating the two kinds of curved surface structures of FIG. 9 respectively, thereby forming a 100×100 matrix of the two kinds of curved surface structures respectively. Using an optical software for simulation, a viewing angle curve of the double layers of the deflecting film is obtained as shown in FIG. 10. It can be seen that the viewing angle of maximum luminance is 20° and the transmittance is 92.1%, thereby satisfying the requirements. According to the actual size of the deflecting films, a plurality of the two kinds of optical curved surface structures are prepared on the surfaces of the deflecting films, in a later preparing process.

### Embodiment 4

A fourth embodiment of the present disclosure provides a fabrication method of a deflecting film capable of deflecting a viewing angle of a liquid crystal display, please refer to FIG. 1 for understanding. The present embodiment fabricates deflecting films used in a backlight unit whose viewing angle curve is shown in FIG. 2. Since the viewing angle of the maximum luminance of the liquid crystal display device is 40°, three layers of deflecting film are fabricated in the liquid crystal display device. The fabrication method specifically includes the following steps.

Step 1, determining a deflection angle of a first deflecting film is 40°/3=13.3°, deflection angles of a second deflecting film and a third deflecting film are both 40°/3=13.3°.

Step 2, according to steps 1-14 of the first embodiment, determining a curved surface structure on a surface of the first deflecting film.

Step 3, determining a curved surface structure of the second deflecting film according to the curved surface structure of the first deflecting film, a curved surface portion of the second deflecting film is the same as that of the first deflecting film, right angles in curved surface structure of the first deflecting film are changed to be acute angles in curved surface structure of the second deflecting film, and the acute angle is 90°−40°*(2−1)/3=76.7°, thereby obtaining a single one curved surface microstructure of the second deflecting film.

Step 4, determining a curved surface structure of the third deflecting film according to the curved surface structure of the first deflecting film, a curved surface portion of the third deflecting film is the same as that of the first deflecting film, right angles in the curved surface structure of the first deflecting film is changed to be acute angles in the curved surface structure of the third deflecting film, and the acute angle is 90°−40°*(3−1)/3=63.3°, thereby obtaining a single one curved surface structure of the third deflecting film, as shown in FIG. 11.

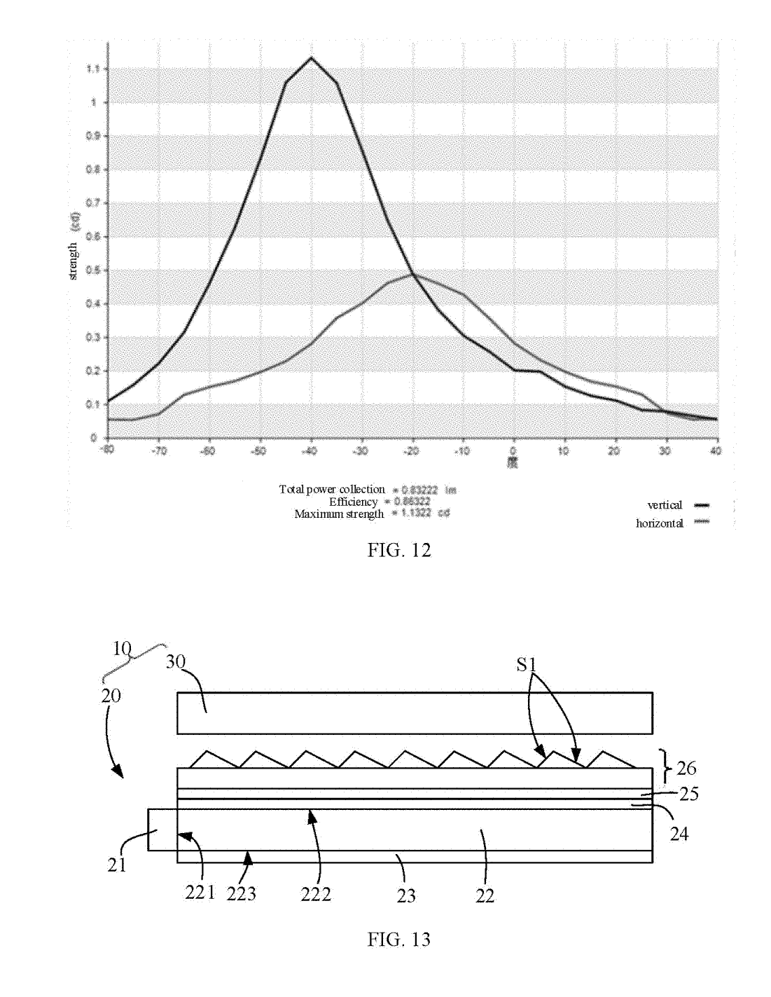

Step 5, duplicating the three kinds of the curved surface structures respectively, thereby forming a 100×100 matrix of the three kinds of curved surface structures respectively. Using an optical software for simulation, a viewing angle curve is obtained as shown in FIG. 12. It can be seen that the viewing angle of maximum luminance is 40° and the transmittance is 92.6%, thereby satisfying the requirements. According to the actual size of the deflecting films, a plurality of the three kinds of optical curved surface structures are prepared on the surfaces of the deflecting films, in a later preparing process.

The fabrication method of the present disclosure fabricates single-layer or matched multi-layer of deflecting film provided with curved surface structures, according to the existing viewing angle characteristics of the backlight unit of the liquid crystal display device and the maximum luminance deflection angle requirement. One or more matched deflecting films are used in the backlight unit of the liquid crystal display device, the curved surface structures of the deflecting film can be fabricated according to the deflection angle of maximum luminance of the liquid crystal display device, and the maximum luminance of the liquid crystal display device can be deflected to sight direction of viewers, meanwhile the viewing angle curve will not change significantly. So the light is mostly used, energy consumption is reduced and light efficiency is improved. At the same time, when the viewing angle of the liquid crystal display device is large, multi-layers of deflecting film is used to solve the problem that the existing single-layer of deflecting film has a gain and a cut-off angle when the deflection angle is large, and the light efficiency is further improved.

In addition, the present application further provides a liquid crystal display device 10 as shown in FIG. 13, which includes a backlight unit 20 and a liquid crystal panel 30. The backlight unit 20 can be a direct-type type or a side-in type, a lower diffusion film 24, an upper diffusion film 25 and a deflecting film 26 are sequentially positioned above alight emitting surface 232 of a light source or a light guide plate. The liquid crystal panel 30 is disposed above the deflecting film 26. The deflecting film 26 includes a plurality of optical curved surface structures designed on a surface thereof. The optical curved surface structures of the deflecting film are fabricated according to the above fabrication method.

The liquid crystal display device provided by the present invention is widely applicable to displays in trains, automobiles, and aircraft cockpits. The display has excellent large viewing angle deflection function, which can efficiently deflect light at a specific angle, especially suitable for the engine room where the display position is fixed, the car dashboard and the like.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A fabrication method of a deflecting film capable of realizing a deflection of a viewing angle of a liquid crystal display device, wherein the liquid crystal display device comprises a backlight unit and a liquid crystal panel, the backlight unit comprises a light source, a light guide plate, a reflective film, a lower diffusion film, an upper diffusion film and the deflecting film; wherein the light guide plate comprises a light incident surface, a light emitting surface adjacent to the light incident surface and four light leakage surfaces, the light source is disposed corresponding to the light incident surface of the light guide plate, and the reflective film is disposed below the light leakage surfaces; wherein the lower diffusion film, the upper diffusion film and the deflecting film are sequentially disposed above the light emitting surface in that order; wherein the liquid crystal panel is disposed above the deflecting film, and a surface of the deflecting film is provided with optical curved surface structures;
wherein the fabrication method of the deflecting film comprises preparing the optical curved surface structures of the deflecting film comprising:
step S01, determining α₂ according to a required deflection angle of the liquid crystal display device;
step S02, defining a distance x₁₀ between the deflecting film and the upper diffusion film;
step S03, determining x₂₀ according to a reserved thickness of optical adhesive and a height of surface microstructure on the surface of the deflecting film, wherein the x₂₀ is a sum of the distance x₁₀, the reserved thickness of optical adhesive and the height of surface microstructure;
step S04, determining x₃₀ according to a distance between the liquid crystal panel and the deflecting film, wherein the x₃₀ is a sum of the x₂₀ and the distance between the liquid crystal panel and the deflecting film;
step S05, determining a refractive index n₁ according to a medium that a light enters before entering the deflecting film, and determining a refractive index n₂ according to a medium that the light enters after entering the deflecting film;
step S06, determining a range of an incident angle θ₁ according to a viewing angle θ at a half-luminance of a viewing angle curve of an incident light before entering the deflecting film, wherein the incident angle θ₁ is in the range of [−θ₁ₘₐₓ, θ₁ₘₐₓ], and θ₁ₘₐₓ is smaller than 90°;
step S07, determining α₁ according to the following formulas when θ₁=0°:
$$\{ \begin{matrix}{n}_{1} sin ( {θ}_{1} + {α}_{1} ) = {n}_{2} sin ( {θ}_{2} + {α}_{1} ) \\ {n}_{2} sin {θ}_{2} = {n}_{1} sin ( {θ}_{1} + {α}_{2} )\end{matrix} ;$$
step S08, assuming that x₀=0, y₀=0, y₁₀=0, y₂₀=0, y₃₀=0;
step S09, starting from 0° and performing segmentations on the range of θ₁ at every Δθ and −Δθ, thereby obtaining a series of θ₁ᵢ and −θ₁ᵢ, wherein θ₁ᵢ₊₁=θ₁ᵢ+Δθ, and i is from 0 to an integral part of θ₁ₘₐₓ/Δθ; θ₁ᵢ₊₁=−θ₁ᵢ−Δθ, and i is from 0 to an integral part of −θ₁ₘₐₓ/Δθ;
step S10, substituting i=1, 0₁₁=Δθ and i=−1, −θ₁₁=−Δθ into the following formulas to obtain a first group of coordinate points x₁₁, y₁₁, x₂₁, y₂₁, x₃₁, y₃₁ of an upper half of a curved surface and a first group of coordinate points x₋₁₁, y₋₁₁, x₋₂₁, y₋₂₁, x₋₃₁, y₋₃₁ of a lower half of the curved surface; substituting i=2; θ₁₂=2×Δθ and i=−2, −θ₁₂=−2×(−Δθ) into the following formulas to obtain a second group of coordinate points x₁₂, y₁₂, x₂₂, y₂₂, x₃₂, y₃₂ of the upper half of the curved surface and a second group of coordinate points x₋₁₂, y₋₁₂, x₋₂₂, y₋₂₂, x₋₃₂, y₋₃₂ of the lower half of the curved surface; and so on, until substituting the integer part of i=θ₁ₘₐₓ/Δθ, θ₁ᵢ=θ₁ₘₐₓ and the integer part of i=−θ₁ₘₐₓ/Δθ, −θ₁ᵢ=−θ₁ₘₐₓ into the following formulas to obtain a last group of coordinate points x₁ₘₐₓ, y₁ₘₐₓ, x₂ₘₐₓ, y₂ₘₐₓ, x₃ₘₐₓ, y₃ₘₐₓ of the upper half of the curved surface and a last group of coordinate points x₋₁ₘₐₓ, y₋₁ₘₐₓ, x₋₂ₘₐₓ, y₋₂ₘₐₓ, x₋₃ₘₐₓ, y₋₃ₘₐₓ of the lower half of the curved surface;
$$\{ \begin{matrix}{n}_{1} sin ( {θ}_{1 i} + {α}_{1 i} ) = {n}_{2} sin ( {θ}_{2 i} + {α}_{1 i} ) \\ {n}_{2} sin {θ}_{2 i} = {n}_{1} sin ( {θ}_{1 i} + {α}_{2 i} ) \\ tan {θ}_{1 i} = \frac{{y}_{1 i} - {y}_{0}}{{x}_{1 i} - {x}_{0}} \\ tan {θ}_{2 i} = \frac{{y}_{2 i} - {y}_{1 i}}{{x}_{2 i} - {x}_{1 i}} \\ tan ( 90 ° - {α}_{1 i} ) = \frac{{y}_{1 i} - {y}_{10}}{{x}_{1 i} - {x}_{10}} \\ tan ( {θ}_{1} + {α}_{2 i} ) = \frac{{y}_{3 i} - {y}_{2 i}}{{x}_{3 i} - {x}_{2 i}} \\ {x}_{20} = {x}_{21} \\ {x}_{30} = {x}_{31}\end{matrix} ;$$
step S11, based on a right-angle curved surface structure, connecting a series of obtained coordinate points (x₁₁, y₁₁), (x₁₂, y₁₂) . . . (x₁ₘₐₓ, y₁ₘₐₓ) of the upper half of the curved surface, at right angles by combining the reserved thickness of optical adhesive, and thereby forming an upper half of a single one of the optical curved surface structures based on a drawing software;
step S12, based on a right-angle curved surface structure, connecting the series of obtained coordinate points (x₋₁₁, y₋₁₁), (x₋₁₂, y₋₁₂) . . . (x₋₁ₘₐₓ, y₋₁ₘₐₓ) of the lower half of the curved surface at right angles by combining the reserved thickness of optical adhesive, and thereby forming a lower half of the single curved surface structure based on the drawing software;
step S13, combining the upper half and the lower half of the single curved surface structure at the coordinate point of (x₁₀, y₁₀), and thereby forming a complete single optical curved surface structure on the surface of the deflecting film; and
step S14, repeating the completed single curved surface structure to form a matrix of 100×100 on the surface of the deflecting film, placing the matrix above the upper diffusion film, and using an optical software for simulation to obtain a viewing angle curve and thereby a viewing angle with a maximum luminance is obtained.

2. The fabrication method according to claim 1, before preparing the optical curved surface structures of the deflecting film, further comprising:
determining an amount of layers of deflecting film according to a required deflection angle of the viewing angle of the liquid crystal display device; wherein when the deflection angle is greater than or equal to 20°, N layers of deflecting film are needed to be prepared , where N=an integer part of (deflection angle/20°) +1; and when the deflection angle is less than 20°, one layer of deflecting film is needed to be prepared.

3. The fabrication method according to claim 2, wherein when N layers of deflecting film are needed to be prepared, the optical curved surface structures of the N layers of deflecting film are prepared by the following method comprising:
preparing a first layer of deflecting film according to the above steps S01-S14, wherein a deflection angle of the first layer of deflecting film is determined as the required deflection angle α₂ divided by N;
preparing an m-th layer of deflecting film comprises:
based on an acute-angle curved surface structure, connecting the series of coordinate points (xₘ₁, yₘ₁), (xₘ₂, yₘ₂), . . . (xₘₘₐₓ, yₘₘₐₓ) obtained during preparing the first layer of the deflecting film and combining with the reserved thickness of optical adhesive through an acute-angle, to form a single acute-angle curved surface structure of the m-th layer, wherein the acute angle of the m-th layer of deflecting film is 90°−α₂*(m−1)/N, m=2˜N; and
repeating the single acute-angle curved surface structure to form a matrix of 100×100 on a surface of the m-th layer of deflecting film, disposing the N layers of deflecting film above the upper diffusion film, and using the optical software for simulation to obtain a viewing angle curve and thereby a viewing angle with a maximum luminance is obtained.

4. The fabrication method according to claim 1, after the step S14, further comprising:
step S15, determining whether a deflection of the viewing angle of the liquid crystal display device satisfies a viewing angle deflection requirement and a transmittance requirement, according to the viewing angle with a maximum luminance obtained in the step S14; if being satisfied, forming a plurality of optical curved surface structures according to an actual size of the deflecting film; and if not being satisfied, narrowing the range of the incident angle θ₁, and repeating the steps S07 to S14 until meeting the requirements.

5. The fabrication method according to claim 1, wherein the optical curved surface structures on the surface of the deflecting film comprise a plurality of wavy microstructures, or a plurality of sawtooth microstructures, or a combination of a plurality of wavy microstructures and a plurality of sawtooth microstructures.

6. The fabrication method according to claim 4, after the step S15, further comprising:
preparing a mold for the deflecting film with the optical curved surface structures; and
using the mold to manufacture the deflecting film with the optical curved surface structures.

7. The fabrication method according to claim 6, wherein preparing a mold for the deflecting film with the optical curved surface structures comprises:
providing a base and coating optical adhesive on the base, wherein a thickness of the optical adhesive is greater than 20 um;
processing the optical adhesive by a photolithography process, thereby forming an optical adhesive layer with the optical curved surface structures thereon;
curing the optical adhesive layer with the optical curved surface structures after baking; and
electroplating the optical adhesive layer with the optical curved surface structures, thereby forming the mold.
